(19) United States
(12) Patent Application Publication
(10) Pub. No.: US 2017/0180367 A1
(43) Pub. Date: Jun. 22, 2017

(54) System And Method For Encrypted And Authenticated Electronic Messaging Using A Central Address Book

(71) Applicant: ClearChat, Inc., New York, NY (US)

(72) Inventor: Jonathan S. Warren, New York, NY (US)

(73) Assignee: ClearChat, Inc., New York, NY (US)

(21) Appl. No.: 14/971,641

(22) Filed: Dec. 16, 2015

(51) Int. Cl. H04L 29/06; H04L 9/32

(52) U.S. Cl. CPC H04L 63/0876; H04L 9/3247; H04L 63/061; H04L 63/062; H04L 63/123; H04L 63/0435

(57) ABSTRACT

A system and method for encrypted and authenticated electronic messaging using a central address book is disclosed herein. In some embodiments, a system for encrypted and authenticated electronic messaging includes a computer system for electronic communication between a sender client and a recipient client, a central address book, and an encrypted message. The central address book includes for each user an alias, a public key, and an address encoded with the public key. The computer system automatically electronically transmits the central address book to each user of the central address book when updated. The encrypted message includes a recipient alias, a recipient public key, and a recipient address encoded with the recipient public key. The recipient public key and the recipient address encoded with the recipient public key are used by the sender client to authenticate the recipient to the sender.

### FIELD OF THE DISCLOSURE

Embodiments of the present disclosure relate to secure electronic communication protocols, and more specifically, to a system and method for encrypting and authenticating electronic messaging using a central address book.

### BACKGROUND

Many existing secure messaging services decrypt messages at a server when received by the sender and then reencrypt the messages when retrieved by the recipient. This involves users trusting that the server will keep their data private. Some applications feature end-to-end encryption, but many of these do not authenticate keys, thereby making such applications susceptible to man-in-the-middle attacks (e.g., where an entity intercepts secure connections by masquerading as the intended destination).

Many of the secure communication solutions currently available are difficult to use and/or vulnerable to attack. For example, TLS/SSL encrypts data between a user and a server with a domain name, and contains extensions for communication between users (e.g., email encryption). These extensions are not user-friendly, rarely used, and require message decryption at the server (e.g., HipChat, Slack, etc.). When connecting to a server over a TLS connection, the web browser receives a public key from a server, which the web browser verifies by receiving a certificate from a certificate authority. The browser trusts the certificate authority because the certificate authority is trusted by a higher certificate authority or because the browser is programmed to inherently trust the particular certificate authority. Accordingly, even if a user trusts the application and related data center, the giant hierarchy of trust created by TLS can be defeated by a resourceful attacker or a rogue certificate authority.

PGP is a secure communication protocol that involves users to manually exchanging public keys and authenticate them using the key's hash (e.g., fingerprint). As a result, PGP is difficult to use correctly, and can be accidentally bypassed in some applications (e.g., by ignoring bad signature notifications provided by Enigmail, a Thunderbird addon).

Trust on First Use (TOFU) is a secure communication protocol that involves a user trusting the first public key received (e.g., Wickr). This involves users trusting the central server when starting a conversation, where the central server could perform a man-in-the-middle attack by using a public key it controls.

Accordingly, secure communication systems and methods are difficult to use and/or susceptible to attack. A need exists for an easy to use application to provide private and secure communication between users without having to trust a server. More specifically, there is a need for a system to exchange encrypted and authenticated messages (e.g., in a group of users). These and/or other needs are addressed by embodiments of the system and method for encrypted and authenticated electronic messaging using a central address book.

### SUMMARY

The present disclosure is directed to a system and method for encrypted and authenticated electronic messaging using a central address book. Disclosed herein is a system for encrypted and authenticated electronic messaging including a computer system for electronic communication between a sender client of a sender and a recipient client of a recipient, a central address book electronically stored on the computer system, and an encrypted message. The central address book has for each user an alias, a public key, and an address encoded with the public key. The computer system automatically electronically transmits the central address book to each user of the central address book when updated. The encrypted message from the sender client is electronically received at the computer system and then electronically forwarded to the recipient client by the computer system. The encrypted message includes a recipient alias, a recipient public key, and a recipient address encoded with the recipient public key. The recipient public key and the recipient address encoded with the recipient public key are used by the sender client to authenticate the recipient to the sender.

Also disclosed herein is a method for encrypted and authenticated electronic messaging including electronically storing on a computer system a central address book, automatically electronically transmitting, by the computer system, the central address book to each user of the central address book when updated, electronically receiving, by the computer system, an encrypted messages from a sender client of a sender, and electronically forwarding, by the computer system, the encrypted message to a recipient client of the recipient. The central address book has for each user an alias, a public key, and an address encoded with the public key. The encrypted message includes a recipient alias, a recipient public key, and a recipient address encoded with the recipient public key. The recipient public key and the recipient address encoded with the recipient public key are used by the sender client to authenticate a recipient to the sender.

Also disclosed herein is a non-transitory computer-readable medium having computer-readable instructions stored thereon which, when executed by a computer system, cause the computer system to perform the steps of electronically storing on a computer system a central address book, automatically electronically transmitting, by the computer system, the central address book to each user of the central address book when updated, electronically receiving, by the computer system, an encrypted messages from a sender client of a sender, and electronically forwarding, by the computer system, the encrypted message to a recipient client of the recipient. The central address book has for each user an alias, a public key, and an address encoded with the public key. The encrypted message includes a recipient alias, a recipient public key, and a recipient address encoded with the recipient public key. The recipient public key and the recipient address encoded with the recipient public key are used by the sender client to authenticate a recipient to the sender.

### BRIEF DESCRIPTION OF THE DRAWINGS

The foregoing features of the invention will be apparent from the following Detailed Description, taken in connection with the accompanying drawings, in which:

FIG. 1 is a diagram showing a computer system on which the present disclosure could be implemented;

FIG. 2 is a diagram showing in more detail hardware and software components of a computer system on which the secure electronic messaging system of the present disclosure could be implemented;

FIG. 3 illustrates processing steps for setting up and maintaining the central address book of the secure electronic messaging system of the present disclosure;

FIG. 4 illustrates processing steps for logging into the secure electronic messaging system of the present disclosure;

FIG. 5 illustrates processing steps for using the central address book of the secure electronic messaging system of the present disclosure;

FIG. 6 illustrates processing steps for generating a public key fingerprint for the secure electronic messaging system of the present disclosure; and

FIG. 7 is a diagram illustrating generating the public key fingerprint of FIG. 6.

### DETAILED DESCRIPTION

Disclosed herein is a system and method for encrypted and authenticated electronic messaging using a central address book. The system is encrypted, meaning that message content is protected from third party viewing (e.g., by an attacker). The system is authenticated, meaning that when a recipient receives a message from the sender, the recipient can be sure that the sender is the one who sent it (and not a third party attacker). Embodiments of the system can be trustless, meaning that users of the system do not need to trust any other entity to keep messages private, other than the other users engaged in conversation.

Embodiments of the system are preferably neither decentralized nor anonymous, and thereby can avoid associated costs, such as an inability to support large attachments, increased CPU resources (e.g., CPU intensive programs may be impractical for execution on smartphones), large and growing block chains which must be maintained by all nodes, etc. Embodiments of the system can be encrypted, authenticated, and trustless, but with less cost to the users (e.g., due to lack of decentralization and anonymity requirements). Messages can be processed in less time on computers and smartphones (e.g., in under 100 milliseconds), as the system uses less CPU resources. Thus, the system can be used for messaging (e.g., instant messaging, email, etc.) and support files of any size.

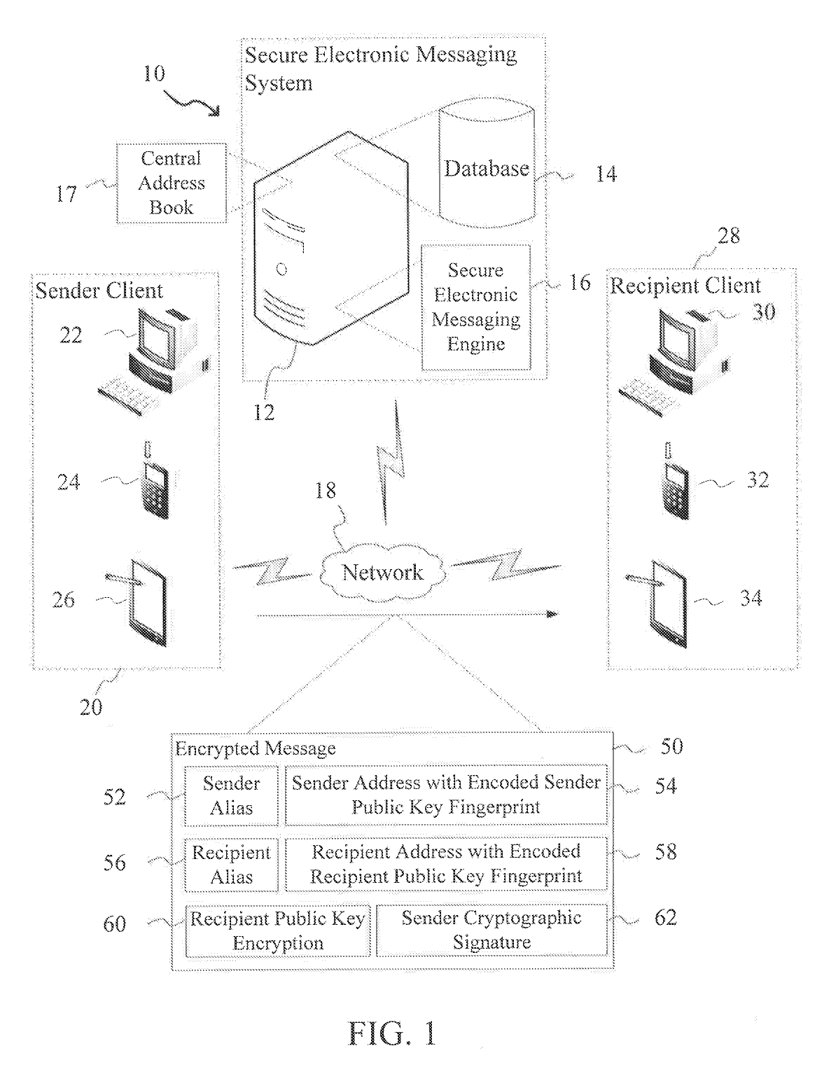

FIG. 1 is a diagram showing a computer system on which the present disclosure could be implemented. The secure electronic messaging system indicated generally at 10, facilitates secure, encrypted, and authenticated electronic messaging between a plurality of users and associated electronic devices. The secure electronic messaging system 10 comprises a computer system 12 (e.g., a server) having a database 14, a secure electronic messaging engine 16, and a central address book 17. The computer system 12 could be any one or more suitable computer servers (e.g., a server with an INTEL microprocessor, multiple processors, multiple processing cores) running any suitable operating system (e.g., Windows by Microsoft, Linux, etc.). The computer system 12 could be hosted in Amazon Web Services (AWS) and could communicate through an Amazon-managed Redis instance. However, use of a server of the secure electronic messaging system 10 to relay messages 50 (and other data) could be optional. Any number of other network topologies could also be used to transfer messages between users, to transfer the central address book 17 (discussed below), and/or to store the central address book 17 for offline users.

The database 14 could be stored on the computer system 12, or located externally (e.g., in a separate database server in communication with the computer system 12). For example, the messages could be stored on an Amazon-managed Postgres instance. Messages could be stored in a Postgres database (e.g., with SQLAlchemy used as a Python-Postgres interface), such that if a user is offline the user will be able to retrieve his messages and if the user uses the same address on multiple devices (e.g., a desktop and mobile device), the user will be able to get the messages on both devices (e.g., the server will not delete the messages after the user receives them). It is noted that messages could include text messages, file messages, and presence information (e.g., notifications that a user has gone online or offline). Presence information could be relayed but transient such that the presence information is not stored (e.g., in the Postgres server). Local data storage could be written in SQLite and/or any other suitable programming language.

The secure electronic messaging system 10 could include a network 18 for internal communication within a company over a variety of computer systems of a plurality of users. The secure electronic messaging system 10 could be web-based (and remotely accessible), for example, such that the secure electronic messaging system 10 communicates through a network 18 over a variety of computer systems of a plurality of users. Network communication could be over the Internet using standard TCP/IP communications protocols (e.g., hypertext transfer protocol (HTTP), secure HTTP (HTTPS), file transfer protocol (FTP), electronic data interchange (EDI), etc.), through a private network connection (e.g., wide-area network (WAN) connection, emails, electronic data interchange (EDI) messages, extensible markup language (XML) messages, file transfer protocol (FTP) file transfers, etc.), or any other suitable wired or wireless electronic communications format. To connect to the server, a single normal continuous TCP socket could be used. Information could be piped to the server through TLS/SSL (e.g., to keep dumb Internet nodes from seeing which address each connection is using).

The client (e.g., user client, admin client) could be designed for Windows and/or OSX and could include a mobile client (e.g., running natively on Android and/or iOS), where if PyQt is used, the UI code for the mobile client would require little modification. In this way, a sender client 20 (e.g., personal computer 22, smartphone 24, tablet computer 16, and/or other electronic devices) could use the secure electronic messaging system 10 to communicate with a recipient client 28 (e.g., personal computer system 30, a smartphone 32, tablet computer 34, and/or other devices) over the network 18.

The secure electronic messaging system 10 could require that each company run its own server 12. Using a centralized server provides the opportunity to provide additional services (e.g., storing messages and files for a long time). The computer system 12 could include one or more servers, such as a web server and/or a communications server. The web server could host the main website, allow a customer administrator to manage their billing, and/or allow a secure electronic messaging system administrator to perform administrative tasks and view statistics. The web server could use Amazon Elastic Beanstalk (which supports scaling) running a Flask web-framework.

The communication server could run on normal EC2 instances and be accessible behind a load balancer which could manage TLS termination. The communications server could run Python (e.g., for performance, scalability, security, and/or ease-of-development) with Python threads or Greenlets used to maintain TCP connections to clients (e.g., 10,000 connections, 400,000 connections, etc.). The CPU tasks to be accomplished by the server are minimal, such as verifying cryptographic signatures (e.g., a single CPU can verify thousands of signatures per second).

The secure electronic messaging system 10 could scale, particularly as all operations are no more than O(log(n)). Scaling could be accomplished by adding servers which communicate through a Redis pubsub system. In such a situation, if the sender client 20 is connected to a first server and the recipient client 28 is connected to a second server, when the sender client 20 electronically transmits a message 50 to the recipient client 28, the first server will look up in the Redis server which server the recipient client 28 is connected to. The first server will then publish the message to the Redis server in the ‘Second Server’ channel to which the second server is listening. The second server receives the message 50, looks up (in an internal data structure) which socket the recipient client 28 is using, and then transmits the message to that socket. All information stored in the Redis server is preferably removed after 24 hours (e.g., with the expiration time periodically refreshed) or after a client disconnects. In such a system, servers could be added or removed at will, including the Redis server, which would require restart of all of the connection servers, but no messages would be lost. Thus, if a server malfunctions and crashes, connected clients could time out (e.g., TCP timeout) after a minute, automatically reconnect to a different server through a load balancer, and download any missed messages after reconnecting. Any messages that were attempted to be sent by the client during disconnection would be sent once reconnected, and the client could keep attempting to send messages until the server 12 sends an acknowledgement. The client could be written in Python and/or any other suitable programming language. The user interface (UI) could be written in QT with the QT interface being PySide or PyQt.

The sender client 20 uses the secure electronic messaging system 10 to electronically transmit an encrypted message 50 to a recipient client 28. The encrypted message 50 includes a sender alias 52 and associated sender address 54, where the sender address 54 includes an encoded sender public key fingerprint (e.g., a hash of the public key). The encrypted message 50 also includes a recipient alias 56 and associated recipient address 58, where the recipient address 58 includes an encoded recipient public key fingerprint. Importantly, the sender alias 52, associated sender address 54, recipient alias 56, and associated recipient address 58 are digitally recorded in a central address book 17 (e.g., maintained by an admin). The address book could be stored in a database 14 of the secure electronic messaging system 10. The cryptographic operations could be written in C, OpenSSL, and/or any other suitable programming language.

The encrypted message 50 further includes a recipient public key encryption 60. More specifically, encrypted message 50 is preferably encrypted using asymmetric encryption. Symmetric key encryption requires a key to both encrypt and decrypt data. Asymmetric encryption involves a pair of mathematically related keys, a public key to encrypt data and a private key to decrypt the data. Accordingly, to transmit data between two users, the sender client 20 (e.g., the first user) encrypts a message with the recipient client's 28 (e.g., the second user) public key. When the message is received, the recipient client 28 decrypts the message with the mathematically paired recipient private key. Thus, communication using asymmetric encryption involves an exchange of public keys, but it does not matter if the public key is seen by an attacker, because the message still involves a private key for decryption.

Encrypted messages require authentication to verify that the public key being used is the correct public key, otherwise such communications could be susceptible to interception by an attacker (e.g., someone who wishes to do harm or view the communications of another). Without authentication, an attacker (e.g., a malicious third user) could modify traffic between users, intercept the communications, and perform a man-in-the-middle attack, where the attacker swaps in his public key when the first two users exchange public keys. In this way, the sender could intend to send his message to the recipient, but unintentionally use the public key of the attacker. The attacker could then intercept the message, decrypt it using his own paired private key, read the message, reencrypt the message using the intended recipient's public key, and then forwards it to the intended recipient. Thus, in such a circumstance, the users would be unaware that their communications are being intercepted.

To authenticate the sender, the encrypted message 50 includes a sender cryptographic signature 62 (e.g., verifying to the recipient that a message 50 came from a particular sender). The cryptographic signature 62 is generated by inputting the sender's private key and the message into a signing algorithm. The cryptographic signature 62 could be a cryptographic hash function, where a hash function is a program that uses data as input to generate a hash value (e.g., a fixed-size alphanumeric string). The three main properties of a hash value are that it is (1) extremely easy to calculate a hash value for any given data, (2) extremely computationally difficult to find any data that has a given hash (e.g., it is infeasible to work backwards), and (3) extremely unlikely that two slightly different messages will have the same hash. The secure electronic messaging system 10 could use one or more hash functions, such as SHA, SHA256, SHA512, RIPEMD160, and/or ECDSA, etc. More specifically, the secure electronic messaging system 10 could use SHA256 and ECDSA for cryptographic signing.

Once the message 50 with the cryptographic signature 62 is received, the recipient client 28 checks the cryptographic signature 62 using a verification function with the sender's public key, the message 50, and the cryptographic signature 62 as inputs. The verification function then outputs either True or False. In this way, users can be certain that a particular sender wrote the message and that only a particular recipient can read it.

To authenticate the recipient, the encrypted message 50 includes the recipient address 58 with encoded recipient public key fingerprint (e.g., verifying to the sender that the message is being sent to a particular recipient). The sender client 20 generates a hash of the recipient's public key (e.g., BM-2DAzePvEK4opfysZwAd1Gftma18gj3BJUX) to ensure that the hash of the recipient public key matches the hash encoded in the recipient's address, thereby authenticating the recipient. More specifically, the secure electronic messaging system 10 could use SHA512 and RIPEMD160 for address generation and various other functions.

The secure electronic messaging system 10 could use AES256 as a symmetric encryption algorithm and/or ECC for asymmetric operations with secp256k1 or Curve 25519 as the elliptic curve. A benefit of secp256k1 is that some finance related companies (e.g., Bitcoin) use secp256k1, such that attackers have a financial incentive to leverage any exploits in secp256k1 against the finance related companies first, thereby providing an early warning of any secp256k1 weaknesses.

An address that includes a hash of a public key is human readable, but not user-friendly (e.g., BM-2DAzePvEK4opfysZwAd1Gftma18gj3BJUX). As a result, the secure electronic communication system 10 of the present disclosure uses a central address book 17 that associates these addresses with a user-friendly alias (e.g., JohnSmith01). The central address book 17 is unique to each company (e.g., a company address book) and could have one admin that maintains the central address book 17 for that company. The central address book 17 minimizes the amount of data entry required. For example, if each user was required to maintain a local address book, then each user must distribute his alias and address to every other user, and add each of those users to his own address book. Thus, for a company of 1,000 users, there would be 1,000,000 manual address book entries to be done by the users.

The secure electronic messaging system 10 uses true end-to-end encryption, meaning that messages will be encrypted by the sender's client 20 and decrypted by the recipient's client 28. Although the secure electronic messaging system 10 relays the encryption keys used by the sender client 20 and recipient client 28, it is not able to modify them. Further, the server 12 of the secure electronic messaging system 10 can see public keys, encrypted messages, encrypted files (including approximate file size), sender client, and recipient client, but not the content of messages, files, or file names. The secure electronic messaging system 10 could be implemented without anonymity or with anonymity (e.g., using Tor). The server 12 could also see when users connect and disconnect. Further, the software running on the server 12 which relays and stores messages and public keys could be closed source and proprietary without requiring any user trust because system security does not depend on any actions of the servers 12. Even if the secure electronic messaging system 10 were malicious or hacked, the messages 50 remain private.

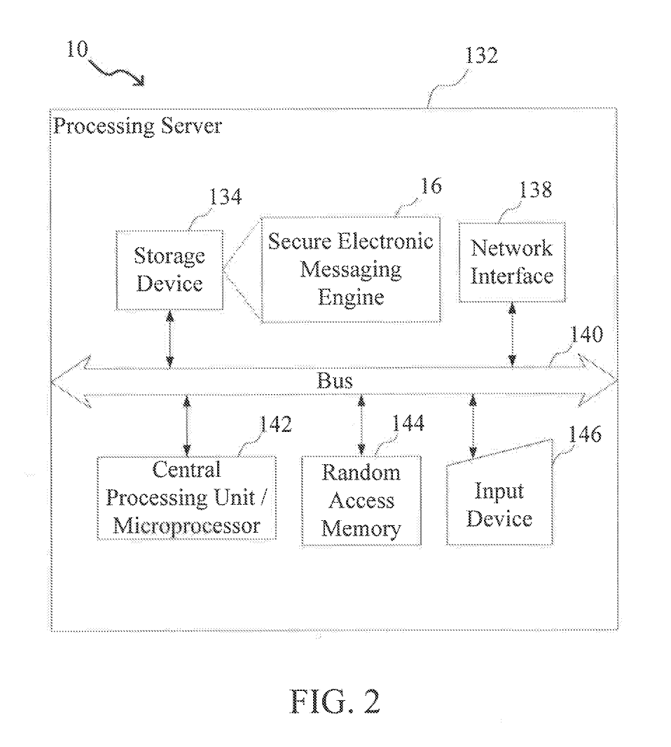

FIG. 2 is a diagram showing in more detail hardware and software components of a computer system on which the secure electronic messaging system 10 of the present disclosure could be implemented. The secure electronic messaging system 10 comprises a processing server 132 which could include a storage device 134, a network interface 138, a communications bus 140, a central processing unit (CPU) (microprocessor) 142, a random access memory (RAM) 144, and one or more input devices 146, such as a keyboard, mouse, etc. The server 132 could also include a display (e.g., liquid crystal display (LCD), cathode ray tube (CRT), etc.). The storage device 134 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.).

The functionality provided by the present disclosure could be provided by a secure electronic messaging program/engine 16, which could be embodied as computer-readable program code stored on the storage device 134 and executed by the CPU 142 using any suitable, high or low level computing language, such as Python, PHP, Java, C, C++, C#, .NET, MATLAB, etc. The network interface 138 could include an Ethernet network interface device, a wireless network interface device, or any other suitable device which permits the server 132 to communicate via the network. The CPU 142 could include any suitable single- or multiple-core microprocessor of any suitable architecture that is capable of implementing and running the engine 16 (e.g., Intel processor). The random access memory 144 could include any suitable, high-speed, random access memory typical of most modern computers, such as dynamic RAM (DRAM), etc.

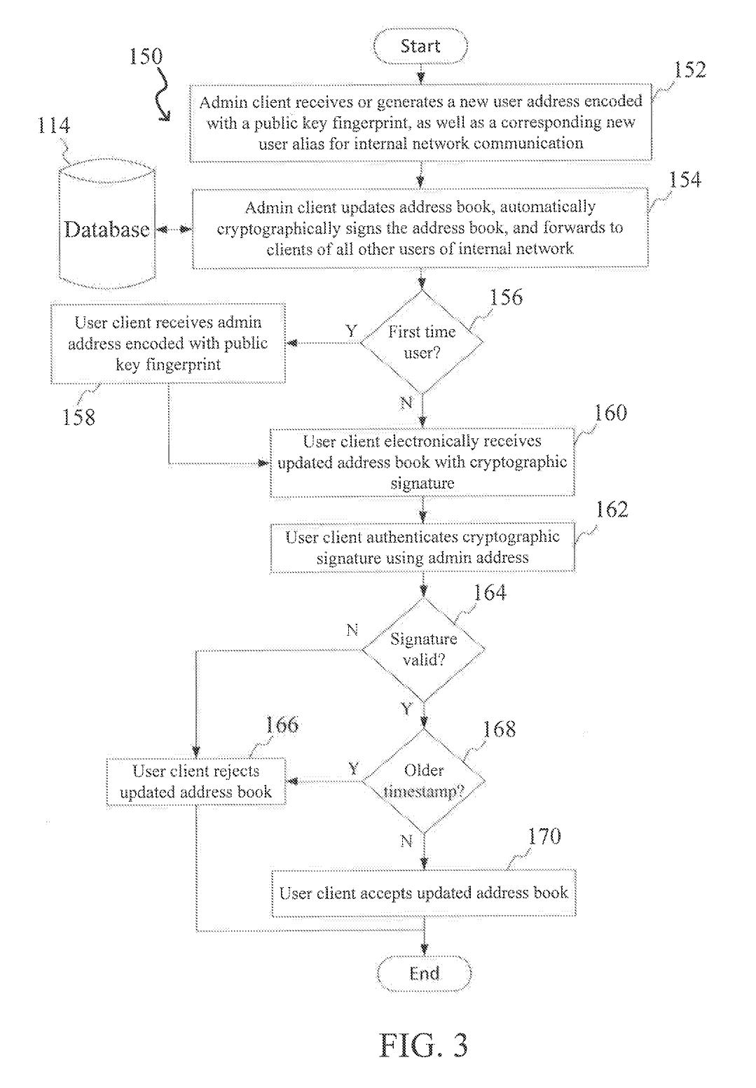

FIG. 3 illustrates processing steps 150 for setting up and maintaining the central address book of the secure electronic messaging system 10 of the present disclosure. When joining a company, a new user provides a new user address to the admin (for addition to the address book), and the admin provides the admin address to the new user. It is anticipated that the admin would be an employee of the company, but this is not required. For example, employees of the company could trust a third party company (e.g., the third party company running the secure electronic messaging system) to maintain the address book. The advantage to such a system is that users could log into the third party website to input their address, rather than relying on an admin within their company.

In step 152, the admin client receives or generates a new user address encoded with a public key fingerprint, as well as a corresponding new user alias for internal network communication. In step 154, the Admin client updates the central address book (stored in database 114), automatically cryptographically signs the address book, and forwards the updated central address book to the clients of all other users of the internal network (e.g., by forwarding the updated central address book to the server). The signed address book could also be stored on the server, so that the address book can be later distributed to clients who were offline at the time.

In step 154, the system determines whether the client receiving the updated address book is a first time user. If so, then in step 158, the user client receives (by user input) the admin address encoded with the admin public key fingerprint, and then proceeds to step 160. If the client receiving the updated address book is not a first time user, then the process proceeds to step 160.

In step 160, the user client electronically receives the updated address book with a cryptographic signature. In step 162 the user client authenticates the cryptographic signature using the admin address encoded with the admin public key fingerprint. In step 164, the client determines whether the signature is valid. If the signature is not valid, the process proceeds to step 166 and the user client rejects the updated address book. If the signature is valid, the system then proceeds to step 168 and determines whether it has an older timestamp than the previously received address book (e.g., determines whether the updated address book is more recent or whether the address book is outdated). If the address book has an older timestamp, then the process proceeds to step 166 and the user client rejects the address book. If instead, the system determines that the timestamp is not older, then the process proceeds to step 170 and the user client accepts the updated address book.

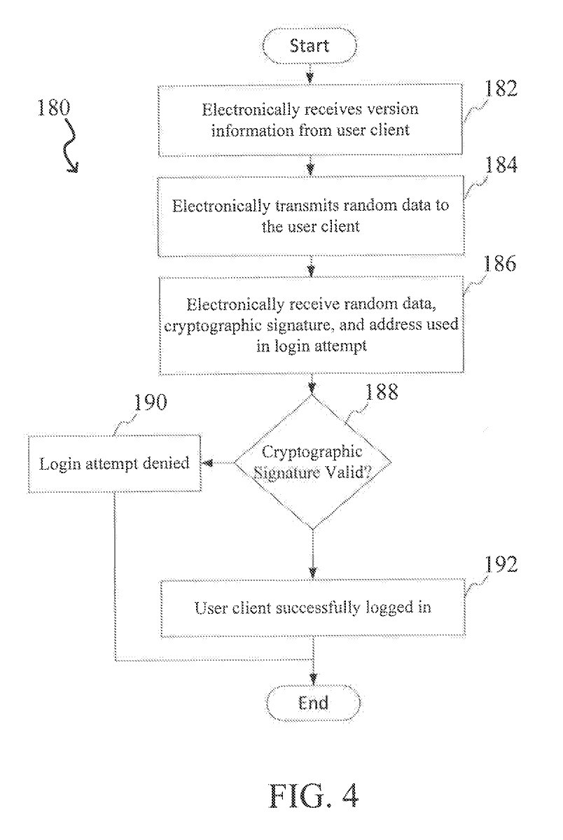

FIG. 4 illustrates processing steps 180 for logging into the secure electronic messaging system of the present disclosure. In step 182, the secure electronic messaging system 10 electronically receives version information from a user client. Usernames and/or passwords are not necessary to log in. In step 184, the secure electronic messaging system 10 electronically transmits random data to the user client. In step 186, the secure electronic messaging system 10 electronically receives random data, a cryptographic signature, and the address used in the login attempt. The client UI could support one or more addresses for one or more companies. In step 188, the secure electronic messaging system determines whether the cryptographic signature is valid. If not, then in step 190, the login attempt is denied. If so, then in step 192, the user client is successfully logged in. Once logged in, the secure electronic messaging system 10 could electronically transmit to the user client any messages addressed to the respective address (e.g., messages that were received while the user had been disconnected).

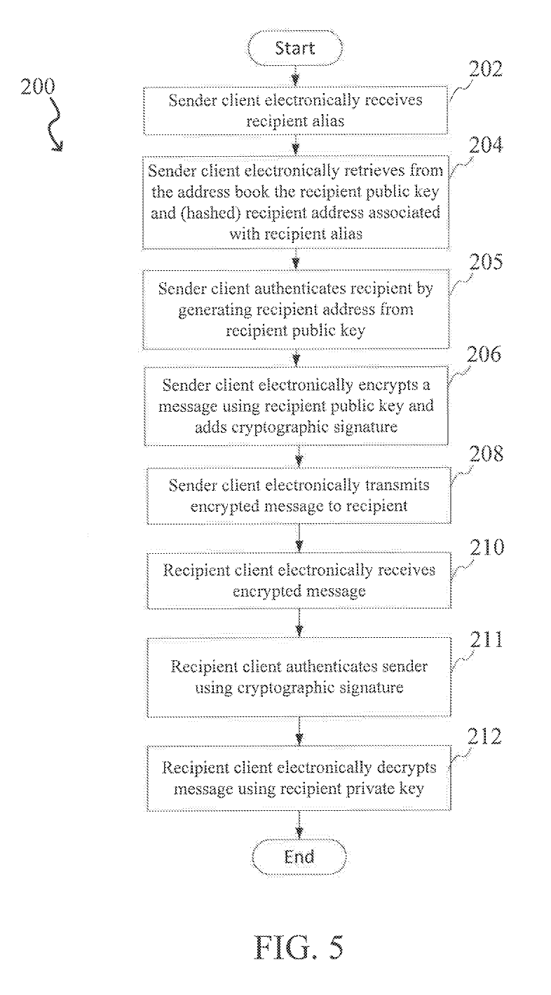

FIG. 5 illustrates processing steps 200 for using the central address book of the secure electronic messaging system 10 of the present disclosure. In step 202, the sender client electronically receives (e.g., via user input) a recipient alias (e.g., JohnSmith01). In step 204, the sender client electronically retrieves from the address book the recipient public key and the (hashed) recipient address associated with the recipient alias. In step 205, the sender client authenticates the recipient client by generating the (hashed) recipient address from the recipient public key. If the generated recipient address does not match the recorded recipient address in the address book, then the message is rejected by the sender client (and/or by the server).

In step 206, the sender client electronically encrypts a message (to be sent by the sender client to the recipient client) using the recipient public key. In step 208, the sender client electronically transmits the encrypted message to the recipient client. In step 210, the recipient client electronically receives the encrypted message. In step 211, the recipient client authenticates the sender using the cryptographic signature (described above). In step 212, the recipient client electronically decrypts the message using the recipient private key.

Further, the secure electronic messaging system 10 supports group messaging by encrypting messages with a randomly generated symmetric key (rater than with the recipient's public key) and then encrypting the symmetric key with each recipient's public key. This way the server only needs to store one copy of the message ciphertext despite that the message is effectively encrypted for each of the multiple recipients. The asymmetrically encrypted symmetric keys could be included in the message header, which allows recipients to detect whether they have received the same message as everyone else in the group (e.g., transcript consistency).

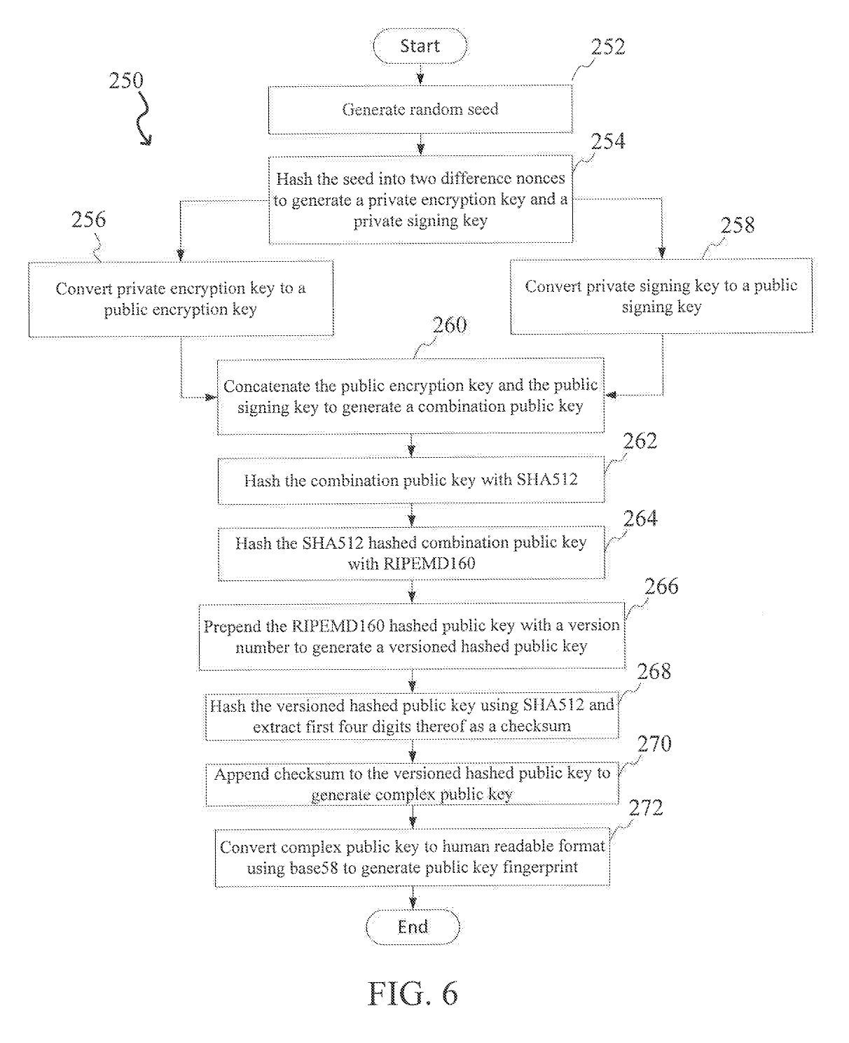

FIG. 6 illustrates processing steps 250 for generating a public key fingerprint for the secure electronic messaging system 10 of the present disclosure. A public key fingerprint is a hash of a public key and is encoded into a user's address (as described above). In step 252, the system generates a random seed and electronically saves the random seed. The random seed could be 256 bits (e.g., about 42 characters long). The random seed could have its own checksum (e.g., to check for typos). In step 254, the system hashes the random seed with two different nonces to generate a private encryption key and a private signing key. In step 256, the system converts the private encryption key to a public encryption key (e.g., using ECC point multiplication). In step 258, the system converts the private signing key to a public signing key (e.g., using ECC point multiplication). It is noted that steps 256 and 258, could be executed in series or in parallel (as shown).

The keys could be generated from random numbers instead of using a random seed. However, an advantage of using the random seed is that the user can export their keys to another electronic device (e.g., smartphone, different computer, etc.). The user would only require copying of a single seed, and then could regenerate the public key and/or future public keys generated from the same random seed (e.g., by incrementing the nonce). The random seed also makes backing up public keys easier as the user's actual keys and addresses can be regenerated if the user later imports their seed from a backup. The random seed could be backed up by taking a picture of a QR-code (e.g., with a smartphone) or printing a QR-code (e.g., with a printer).

In step 260, the system concatenates the public encryption key and the public signing key to generate a combination public key. The combination public key includes both the public encryption key and the public signing key in one string. In step 262, the system hashes the combination public key with SHA512. In step 264, the system hashes the SHA512 hashed combination public key with RIPEMD160. In step 266, the system prepends the RIPEMD160 hashed public key with a version number (e.g., 1-byte version number) to generate a versioned hashed public key. In step 268 the system hashes the versioned hashed public key using SHA512 and extracts the first four digits (e.g., first four bytes) thereof for use as a checksum. In step 270, the system appends the checksum to the versioned hashed public key to generate a complex public key. In step 272, the system converts the complex public key to human readable format using base58 to generate a public key fingerprint.

It is noted that the public key fingerprint and/or address could be made shorter (without sacrificing cryptographic strength) by incrementing the nonces and generating keys until the RIPEMD160 has contains a NULL byte as the first byte, and then not storing the NULL byte.

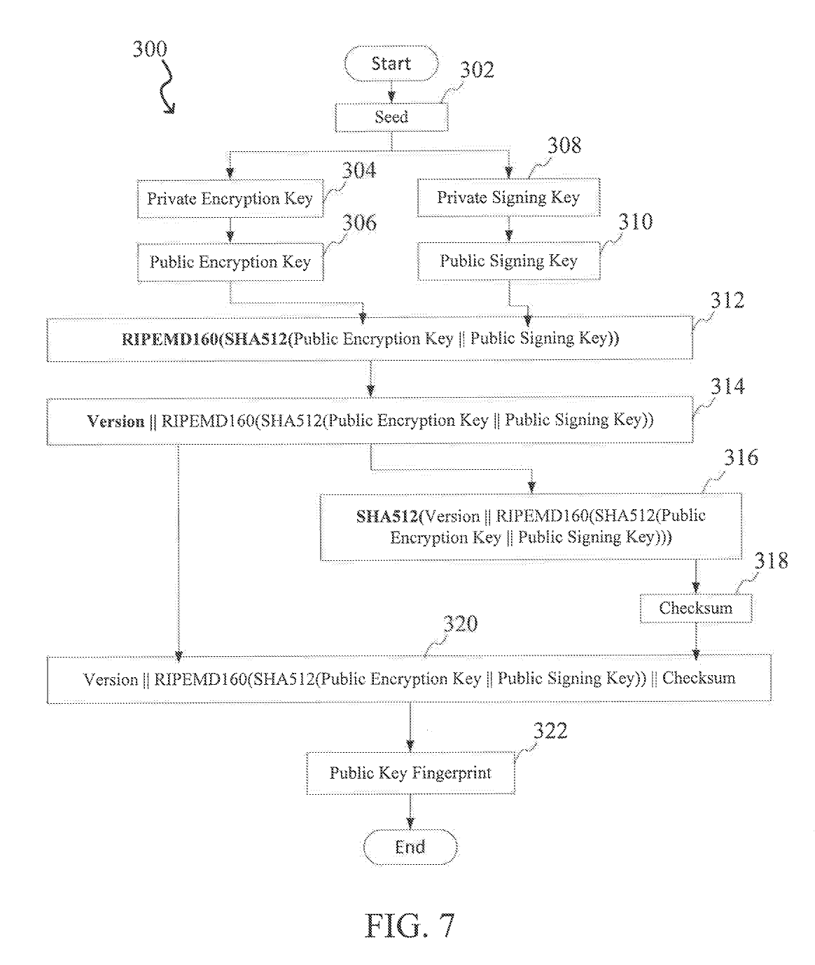

FIG. 7 is a diagram 300 illustrating generating the public key fingerprint of FIG. 6. In step 302, the system generates the random seed 302. The system then hashes the seed to generate a private encryption key 304 and a private signing key 308. The private encryption key 306 is then converted to a public encryption key 306, and the private signing key 308 is converted to a public signing key 310. The public encryption key 306 and the public signing key 310 are concatenated and then hashed to generate a RIPEMD160 hashed public key 312. More specifically, the concatenated combination public key is first hashed using SHA512, and then the resulting hashed public key is again hashed using RIPEMD160. The system then prepends the RIPEMD160 hashed public key 312 with a version number to generate a versioned hashed public key 314. The versioned hashed public key 314 is hashed using SHA512 to generate a SHA512 versioned hashed public key 316, the first four digits of which are extracted to be used as a checksum 318. This checksum 318 is then appended to the versioned hashed public key 314 to generate a complex public key 320. The system then converts the complex public key 320 to human readable format to generate a public key fingerprint 322.

Having thus described the invention in detail, it is to be understood that the foregoing description is not intended to limit the spirit or scope thereof. It will be understood that the embodiments of the present invention described herein are merely exemplary and that a person skilled in the art may make many variations and modification without departing from the spirit and scope of the invention. All such variations and modifications, including those discussed above, are intended to be included within the scope of the invention.

What is claimed is:

1. A system for encrypted and authenticated electronic messaging comprising:
a computer system for electronic communication between a sender client of a sender and a recipient client of a recipient;
a central address book electronically stored on the computer system, the central address book including for each user an alias, a public key, and an address encoded with the public key, the computer system automatically electronically transmitting the central address book to each user of the central address book when updated; and
an encrypted message from the sender client electronically received at the computer system and electronically forwarded to the recipient client by the computer system, the encrypted message including a recipient alias, a recipient public key, and a recipient address encoded with the recipient public key, the recipient public key and the recipient address encoded with the recipient public key used by the sender client to authenticate the recipient to the sender.

2. The system of claim 1, wherein the encrypted message further includes a sender cryptographic signature, the sender cryptographic signature used by the recipient client to authenticate the sender to the recipient.

3. The system of claim 1, wherein the computer system transmits the updated central address book with an admin cryptographic signature for each user to authenticate the updated central address book.

4. The system of claim 1, wherein the computer system electronically receives a user cryptographic signature and a user address when a user attempts to log in.

5. The system of claim 1, wherein the recipient address encoded with the recipient public key comprises a recipient public key fingerprint, the recipient public key fingerprint including a hash of the recipient public key.

6. The system of claim 1, wherein the encrypted message is encrypted with the recipient's public key.

7. The system of claim 1, wherein the encrypted message is encrypted with a symmetric key for group messaging, the symmetric key being encrypted with the recipient's public key.

8. A method for encrypted and authenticated electronic messaging comprising:
electronically storing on a computer system a central address book, the central address book including for each user an alias, a public key, and an address encoded with the public key;
automatically electronically transmitting, by the computer system, the central address book to each user of the central address book when updated;
electronically receiving, by the computer system, an encrypted messages from a sender client of a sender, the encrypted message including a recipient alias, a recipient public key, and a recipient address encoded with the recipient public key, the recipient public key and the recipient address encoded with the recipient public key used by the sender client to authenticate a recipient to the sender; and
electronically forwarding, by the computer system, the encrypted message to a recipient client of the recipient.

9. The method of claim 8, wherein the encrypted message further includes a sender cryptographic signature, the sender cryptographic signature used by the recipient client to authenticate the sender to the recipient.

10. The method of claim 8, wherein the computer system transmits the updated central address book with an admin cryptographic signature for each user to authenticate the updated central address book.

11. The method of claim 8, further comprising electronically receiving at the computer system a user cryptographic signature and a user address of a user attempting to log in.

12. The method of claim 8, wherein the recipient address encoded with the recipient public key comprises a recipient public key fingerprint, the recipient public key fingerprint including a hash of the recipient public key.

13. The method of claim 8, wherein the encrypted message is encrypted with the recipient's public key.

14. The method of claim 8, wherein the encrypted message is encrypted with a symmetric key for group messaging, the symmetric key being encrypted with the recipient's public key.

15. A non-transitory computer-readable medium having computer-readable instructions stored thereon which, when executed by a computer system, cause the computer system to perform the steps of:
electronically storing on a computer system a central address book, the central address book including for each user an alias, a public key, and an address encoded with the public key;
automatically electronically transmitting, by the computer system, the central address book to each user of the central address book when updated;
electronically receiving, by the computer system, an encrypted messages from a sender client of a sender, the encrypted message including a recipient alias, a recipient public key, and a recipient address encoded with the recipient public key, the recipient public key and the recipient address encoded with the recipient public key used by the sender client to authenticate a recipient to the sender; and
electronically forwarding, by the computer system, the encrypted message to a recipient client of the recipient.

16. The computer-readable medium of claim 15, wherein the encrypted message further includes a sender cryptographic signature, the sender cryptographic signature used by the recipient client to authenticate the sender to the recipient.

17. The computer-readable medium of claim 15, wherein the computer system transmits the updated central address book with an admin cryptographic signature for each user to authenticate the updated central address book.

18. The computer-readable medium of claim 15, further comprising electronically receiving at the computer system a user cryptographic signature and a user address of a user attempting to log in.

19. The computer-readable medium of claim 15, wherein the recipient address encoded with the recipient public key comprises a recipient public key fingerprint, the recipient public key fingerprint including a hash of the recipient public key.

20. The computer-readable medium of claim 15, wherein the encrypted message is encrypted with the recipient's public key.

21. The computer-readable medium of claim 15, wherein the encrypted message is encrypted with a symmetric key for group messaging, the symmetric key being encrypted with the recipient's public key.
